(19) United States
(12) Patent Application Publication
(10) Pub. No.: US 2024/0427850 A1
(43) Pub. Date: Dec. 26, 2024

(54) APPARATUS, SERVER AND SYSTEM FOR AUTHENTICATION OF DIGITAL ALBUM, AND METHOD THEREOF

(71) Applicant: YG PLUS, INC., Seoul (KR)

(72) Inventors: Dong Hun LEE, Goyang-si (KR); Taek Bu KIM, Yongin-si (KR)

(73) Assignee: YG PLUS, INC., Seoul (KR)

(21) Appl. No.: 18/749,917

(22) Filed: Jun. 21, 2024

(30) Foreign Application Priority Data
Jun. 23, 2023 (KR) 10-2023-0081427

(51) Int. Cl. G06F 21/10

(52) U.S. Cl. CPC G06F 21/1011

(57) ABSTRACT

The present disclosure relates to authentication of a digital album. A method of authenticating a digital album performed on a user device may include acquiring identification information related to the digital album, transmitting the acquired identification information to a first server for the authentication of the digital album, and receiving at least one content corresponding to the identification information from a second server different from the first server.

### CROSS-REFERENCE TO RELATED APPLICATIONS

This application claims the priority of Korean Patent Application No. 10-2023-0081427 filed on Jun. 23, 2023, in the Korean Intellectual Property Office, the disclosure of which is incorporated herein by reference.

### BACKGROUND

### Field

The present disclosure relates to authentication of a digital album. More particularly, the present disclosure relates to an apparatus, server, system for authentication of a digital album, and a method thereof.

### Description of the Related Art

A digital album is a new concept album that may allow a user to listen to music without existing media such as a long-playing record (LP), a cassette tape, or a compact disc (CP). A physical album using the media such as the existing CD generates a significant amount of waste every year. A digital album using information technology (IT) such as near field communication (NFC) or a quick response (QR) code may replace CD and reduce waste, and meet global demands for eco-friendliness.

The digital album based on information technology (IT) technology may contribute to a music ecosystem in a reasonable way. Various types of content may be provided in an integrated form through the NFC or QR code. In addition, by utilizing the IT technology to issue the digital album, it becomes possible to implement automated services in chart aggregation, etc.

The concept of the digital album may be applied to a variety of content. Through the interaction of the physical media and smartphones, the public may enjoy content, such as music, movies, webtoons, and novels linked to the physical media, or a digital album containing such content.

According to the method, the content may be distributed or transmitted through a public transmission method or a wireless network through the physical medium instead of being distributed directly physically. For example, the digital album may be transmitted through a platform. In this case, it may become more difficult for content producers such as artists or production companies to control illegal distribution of content. With the introduction of the digital album, there is a need to develop a system that allows a content producer to participate in the distribution of content in a reasonable way.

### SUMMARY

An object to be achieved by the present disclosure is to provide an authentication method capable of increasing fairness in a method of providing content using a new medium.

Another object to be achieved by the present disclosure is to provide an authentication system, server, and apparatus capable of transparently managing a distribution of content.

Still another object to be achieved by the present disclosure is to provide an authentication method capable of effectively confirming a distribution status of various types of content.

According to an aspect of the present disclosure, a method of authenticating a digital album performed on a user device may include acquiring identification information related to the digital album, transmitting the acquired identification information to a first server for the authentication of the digital album, and receiving at least one content corresponding to the identification information from a second server different from the first server.

According to an exemplary embodiment, the method may further include outputting a screen including an image of the digital album through a display.

According to an exemplary embodiment, the at least one content may include the image of the digital album.

According to an exemplary embodiment, the method may further include outputting a screen including a message related to the authentication of the digital album through a display.

According to an exemplary embodiment, the identification information related to the digital album may be linked to a physical medium physically separated from the user device.

According to an exemplary embodiment, the at least one content may include at least one of a video, a sound source, an image, or text.

According to an exemplary embodiment, the operation of receiving the at least one content may include receiving data related to at least one of the video, sound source, image, or text.

According to another aspect of the present disclosure, a method of authenticating a digital album performed on a first server may include acquiring identification information related to the digital album from a user device, comparing issuance information pre-stored in the first server and the acquired identification information, and transmitting a message including the identification information related to the digital album and identification information of the user device to a second server according to the comparison result.

According to an exemplary embodiment, the method may further include transmitting a message related to the comparison result to the user device.

According to an exemplary embodiment, at least one content corresponding to the identification information related to the digital album may be transmitted from the second server to the user device according to the message.

According to an exemplary embodiment, the at least one content may include at least one of a video, a sound source, an image, or text.

According to another aspect of the present disclosure, a method of providing a digital album from a first server may include receiving identification information related to the digital album and identification information of a user device from an external second server, and transmitting at least one content corresponding to the identification information related to the digital album to the user device.

According to an exemplary embodiment, the identification information related to the digital album and the at least one content may be mapped to each other and pre-stored in the first server or a database accessible from the first server.

According to an exemplary embodiment, the identification information related to the digital album may be linked to a physical medium physically separated from the user device.

According to an exemplary embodiment, the at least one content may include at least one of a video, a sound source, an image, or text.

According to an exemplary embodiment, the operation of transmitting the at least one content may include transmitting data related to at least one of the video, sound source, image, or text.

According to another aspect of the present disclosure, a user device may include a memory, a communication circuit, and a processor connected to the memory and the communication circuit.

According to an exemplary embodiment, the memory stores instructions executed to enable the processor to acquire identification information related to a digital album, transmit the acquired identification information to a first server for authentication of the digital album, and receive at least one content corresponding to the identification information from a second server different from the first server.

According to another aspect of the present disclosure, a server may include a memory, a communication circuit, and a processor connected to the memory and the communication circuit.

According to an exemplary embodiment, the memory stores instructions executed to enable the processor to acquire identification information related to a digital album from a user device, compare issuance information pre-stored in the server and the acquired identification information, and transmit a message including the identification information related to the digital album and identification information of the user device to an external server.

According to another aspect of the present disclosure, a server may include a memory, a communication circuit, and a processor connected to the memory and the communication circuit.

According to an exemplary embodiment, the memory stores instructions executed to enable the processor to receive identification information related to a digital album and identification information of a user device from an external server and transmit at least one content corresponding to the identification information related to the digital album to the user device.

According to the method, system, server, and apparatus for authentication of a digital album of the present disclosure, it is possible for a content provider to directly confirm or control the distribution of content following the issuance of the digital album using the electronic system.

According to the method, system, server, and apparatus for authentication of a digital album of the present disclosure, a fair content consumption ecosystem can be established.

According to the method, system, server, and apparatus for authentication of a digital album of the present disclosure, it is possible to effectively and stably authenticate a digital album.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram for describing a content authentication and provision environment according to an exemplary embodiment of the present disclosure;

FIG. 2 is a flowchart for describing a method of authenticating a digital album on a user device according to an exemplary embodiment of the present disclosure;

FIG. 3 is a flowchart for describing a method of authenticating a digital album in an authentication server according to an exemplary embodiment of the present disclosure;

FIG. 4 is a flowchart for describing a method of providing content from a content providing server according to an exemplary embodiment of the present disclosure;

FIG. 5 is a diagram illustrating an authentication and transmission scenario in a system for authentication of a digital album according to an exemplary embodiment of the present disclosure;

FIG. 6 is a diagram illustrating an authentication and transmission scenario in a system for authentication of a digital album according to an exemplary embodiment of the present disclosure;

FIG. 7 is a diagram illustrating an authentication and transmission scenario in a system for authentication of a digital album according to an exemplary embodiment of the present disclosure;

FIG. 8 is a diagram illustrating an authentication and transmission scenario in a system for authentication of a digital album according to an exemplary embodiment of the present disclosure;

FIG. 9 is a diagram illustrating an authentication screen of a user device according to an exemplary embodiment of the present disclosure;

FIG. 10 is a block diagram illustrating a configuration of a user device according to an exemplary embodiment of the present disclosure; and

FIG. 11 is a block diagram illustrating a configuration of a server according to an exemplary embodiment of the present disclosure.

### DETAILED DESCRIPTION OF THE EMBODIMENT

Hereinafter, various exemplary embodiments of the present disclosure will be described with reference to the accompanying drawings. The present disclosure is not limited to exemplary embodiments set forth herein, but may be modified in various different forms. The present exemplary embodiments are merely provided to ensure that the disclosure of the present disclosure is complete and to inform those skilled in the art of the invention to which the invention pertains of the scope of the present disclosure, and the present disclosure may not be defined by the scope of the claims. Throughout the accompanying drawings, similar components will be denoted by the same or similar reference numerals.

In this document, an expression “have,” “may have,” “include,” “may include,” or the like, indicates existence of a corresponding feature (for example, a numerical value, a function, an operation, a component such as a part, or the like), and does not exclude existence of an additional feature.

In this document, an expression “A or B,” “at least one of A and/or B,” “one or more of A and/or B,” or the like, may include all possible combinations of items enumerated together. For example, “A or B,” “at least one of A and B,” or “at least one of A or B” may indicate all of 1) a case in which at least one A is included, 2) a case in which at least one B is included, or 3) a case in which both of at least one A and at least one B are included.

In this document, for example, “command,” “instruction,” “control information,” “message,” “information,” “data,” “packet,” “data packet,” “intent,” and/or “signal” transmitted and received between a first electronic device(s) and a second electronic device(s) may include an idea or a specific electrical expression (e.g., digital sign/analog physical quantity) that may be perceived by humans regardless of the expression or may refer to itself. It will be apparent to those skilled in the art to which the present disclosure disclosed in this document pertains that the exemplary expressions listed above may be interpreted in various ways depending on the context in which the expressions are used. In this document, “is greater than B” not only means “is greater than B,” but also “is equal to or greater than B.”

Terms used in this document may be used only to describe specific exemplary embodiments rather than restricting the scope of other exemplary embodiments. Singular forms may include plural forms unless the context clearly indicates otherwise. All terms used herein including technical and scientific terms have the same meanings as those that are generally understood by a person skilled in the art described in this document. Terms defined in a general dictionary among terms used in this document may be interpreted as meanings that are the same as or similar to meanings within a context of the related art, and are not interpreted as ideal or excessively formal meanings unless clearly defined in this document. In some cases, terms may not be interpreted to exclude exemplary embodiments of this document even though they are defined in this document.

In describing various exemplary embodiments of the present disclosure, descriptions of technical contents that are well known in the technical field to which the present disclosure pertains and are not directly related to the present disclosure will be omitted. This is to convey the gist of the present disclosure more clearly.

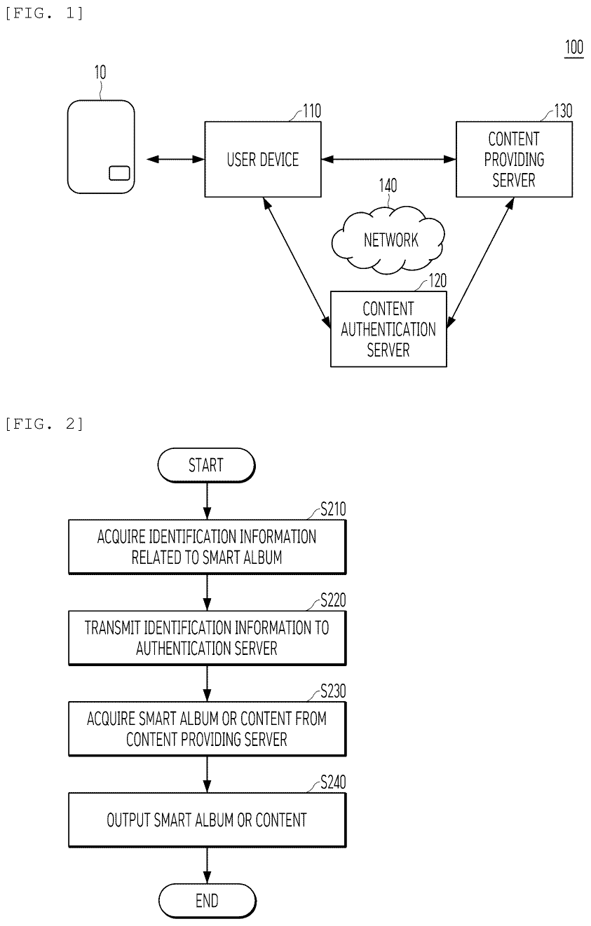

FIG. 1 is a diagram for describing an authentication system according to an exemplary embodiment of the present disclosure.

Referring to FIG. 1, an authentication system 100 according to an exemplary embodiment of the present disclosure may include a physical medium 10, at least one user device 110, an authentication server 120, and a content providing server 130. The authentication system 100 illustrated in FIG. 1 may be modified in such a way that some components are omitted or added according to various exemplary embodiments. The authentication server 120 and the content providing server 130 may be referred to as a first server and a second server in various exemplary embodiments of the present disclosure.

The user device 110 may purchase a digital album including digitized content through a purchase of the physical medium 10 or goods including the physical medium 10. A user may enjoy a digital album or digitized content on the user device 110 through the physical medium 10. The digital album or the digitized content may be transmitted to the user device 110 through the network 140.

In various exemplary embodiments of the present disclosure, the physical medium 10 may be present in the form that is integrated into, included in, disposed in, or embedded in goods corresponding to the digital album. The goods corresponding to the digital album may mean that a title or an image of the digital album displayed on the user device 110 and a title or an image displayed on at least part of the goods match each other. Alternatively, this may mean that the title or image of the content included in the digital album on the user device 110 and the title or image displayed on at least part of the goods match each other.

The physical medium 10 may correspond to the digital album according to various exemplary embodiments of the present disclosure. The physical medium 10 may include at least one of a near field communication (NFC) chip, a quick response (QR) code, a barcode, a radio frequency identification (RFID) chip, an identification code, or an image.

The physical medium 10 may be distributed in various ways. The physical medium 10 may be embedded in various types of goods, such as a photo card, a long-playing record (LP), a compact disc (CD), a mini CD, or a cassette tape made of various materials such as paper or plastic, or may be disposed on or attached to the goods, or distributed integrally with the goods. In this case, the physical medium 10 may be physically spaced apart from or physically separated from the user device 110 on a daily basis.

Purchasing or possessing a digital album by a user may mean purchasing or owning a digital album or content included in the digital album provided through a network through the physical medium 10. Purchasing or possessing a digital album by a user may conceptually correspond to purchasing and owning goods including the physical medium 10 as physical goods (e.g., photo card, album, CD, or artist's signature, etc.). The act of purchasing the physical medium 10 may conceptually correspond to the act of purchasing the digital album. The digital album may include the physical medium 10 along with photo card, LP, CD, or artist's signature, etc. In addition, purchasing or possessing a digital album by a user may mean that the user purchases or possesses the right to enjoy digital content that can be transmitted and received over a network.

The physical goods may correspond to the digital album that exists in the form of data in a virtual space through the physical medium 10. The image or title that is the same or similar to the image or title displayed on the physical medium 10 or goods (e.g., a photo card) purchased along with the physical medium 10 may be output through the user device 110 according to the operation of the user device 110 interacting with the physical medium 10.

The user may confirm the content or digital album linked to the physical medium 10 on the user device 110. The user device 110 may access the digital album through the physical medium 10.

The operation of accessing the digital album through the physical medium 10 may include an operation of acquiring identification information of a digital album or identification information of content corresponding to the digital album from the user device 110 or an operation of acquiring a digital album or content corresponding to the digital album according to an operation in which a user recognizes or tags the physical medium 10 through the user device 110, connects the physical medium 10 to the user device 110, or inputs a code displayed in the physical medium 10.

Hereinafter, the content corresponding to the digital album may conceptually mean specific content included in the digital album. Unlike the traditional media such as CD, the digital album may be distributed (or transmitted) over the network. The content corresponding to the digital album refers to content that the user may enjoy using an application through the goods when the user purchases the goods corresponding to the digital album. In various exemplary embodiments of the present disclosure, the content corresponding to the digital album may be expressed in various ways, such as the content linked to the digital album or the content included in the digital album. According to an exemplary embodiment, the content may include a non-fungible token (NFT) or may be transmitted in the form of an NFT.

The user device 110 may acquire identification information related to the digital album from the physical medium 10. When the user tags or connects the user device 110 to the physical medium 10 or recognizes the physical medium 10 on the user device 110, the user device 110 may acquire the identification information related to the digital album corresponding to the physical medium 10. The identification information related to the digital album may include at least one of the identification information (hereinafter referred to as the identification information of the digital album) identifying the digital album or the identification information (hereinafter referred to as the identification information of the content) identifying the content included in the digital album.

For example, when the user device 110 recognizes the physical medium 10 or a QR code attached to the physical medium 10 through a camera (or image sensor), the user device 110 may acquire the identification information related to the digital album in response to the operation of recognizing the QR code. Alternatively, the user device 10 may acquire the identification information related to the digital album in response to the operation in which the user device 110 contacts the NFC chip. The NFC chip may include the identification information related to the digital album. Alternatively, the user device 10 may acquire the identification information related to the digital album using the information stored in the NFC chip. Alternatively, the user device 10 may acquire the identification information related to the digital album in response to an operation of interconnecting with a storage medium in which the identification information related to the digital album is stored.

The identification information of the digital album may have different values according to the digital album purchased by the user. Even if the plurality of digital albums is identical in appearance, the identification information of the plurality of digital albums may have different values. In other words, the digital albums that are differentiated in the physical space may be given with different identification information. Therefore, even if the digital albums conceptually include the same content, the identification information of the digital albums may be different.

On the other hand, the identification information of the content may have different values depending on the details of the content. Even if the digital albums are physically different from each other, when the content is the same, the identification information of the content may be the same. However, when the content has different details, the identification information of each content may have different values. However, according to various exemplary embodiments of the present disclosure, different identification information may be assigned to contents with the same detail.

In various exemplary embodiments of the present disclosure, the term “identification information” is used as information to confirm whether the content and/or digital album purchased by the user has been issued by a legitimate rights holder, but the identification information may be expressed in other ways, such as the authentication information or the identification code.

The user device 100 may be a device that implements the digital album purchased by a user. The user device 100 may play the content included in the digital album or display the content through the display. The digital album or applications for outputting the content included in a digital album may be installed on the user device 100. The applications may vary depending on a service provider (or platform) providing the digital album service.

The user device 100 may be a device of a user who has purchased or possesses a digital album. A user may purchase the digital album through the user device 100 and possess the purchased digital album. Hereinafter, the user device 100 may be referred to as an electronic device.

The user device 100 may transmit the identification information related to the digital album acquired through the physical medium 10 to the authentication server 120 and acquire the digital album from the content providing server 130. The user device 100 may acquire at least some of the content linked to the digital album from the content providing server 130. The content linked to the digital album may include at least one of the image, video, text, or sound source (or sound).

The digital album may be an album including the sound source. In this case, the title of the sound source may be displayed on the physical medium 10 or on goods including the physical medium 10. The title of the sound source may be the same as the title of the sound source included in the digital album. Likewise, the screen related to the digital album output from the user device 100 may include the title of the same sound source as the title of the sound source displayed on the physical medium 10. In this way, the information for the user to identify content may be displayed on the medium 10.

In this way, the information (e.g., the title of the sound source, the title of the movie, the title of the webtoon, etc.) for the user to identify the content may be equally included in the screen displayed through the dedicated application on the user device 100.

The information (e.g., the name of the digital album) for the user to identify the digital album may be equally included in the screen displayed through the dedicated application on the user device 100. When the user device 100 interacts with the physical medium 10 on which the name of the digital album is displayed, the name of the digital album may be displayed on the display of the user device 100 through various operations presented below.

The operation of acquiring the digital album may include the operation of acquiring at least some of the content corresponding to the digital album. The operation of acquiring the digital album may include the operation of acquiring at least some of content-related information linked to the digital album. The operation of acquiring the digital album may include the operation of acquiring the information related to the digital album. For example, the operation may include acquiring a cover image of the digital album.

At least one user device 100 may be implemented as a computer capable of accessing a remotely located device or server through a network. The computer may include, for example, a desktop, a laptop, navigation, a notebook equipped with a web browser, and the like.

At least one user device 100 may be a wireless communication device that guarantees portability and mobility. Examples of at least one user device 100 may include a device that supports navigation, a personal communication system (PCS), a global system for mobile communication (GSM), a personal digital cellular (PDC), a personal handyphone system (PHS), personal digital assistant (PDA), international mobile telecommunication (IMT)-2000, code division multiple access (CDMA)-2000, W-code division multiple access (W-CDMA), and a wireless broadband, and any type of handheld-based wireless communication devices such as a smartphone, a smart pad, and a tablet PC.

The authentication server 120 may perform various types of authentication related to the digital album. The authentication server 120 may authenticate whether the digital (or content) issued by a album (or content) is an album legitimate right holder. The authentication server 120 may authenticate whether the digital album is genuine based on the identification information (e.g., identification information of the digital album) related to the digital album.

The authentication server 120 may also perform copyright authentication related to the digital album. The authentication server 120 may perform the authentication related to the copyright for the digital album based on the identification information (e.g., the identification information of the digital album) related to the digital album. Alternatively, the authentication server 120 may interact with a separate server that performs the authentication related to the copyright.

Alternatively, the authentication server 120 may perform various types of authentication related to the content. The authentication server 120 may authenticate whether the content has been issued by a legitimate right holder based on the identification information related to the digital album (e.g., identification information related to content).

The authentication server 120 may also perform the copyright authentication related to the content. The authentication server 120 may perform the authentication related to the copyright of the content based on the identification information of the content. Alternatively, the authentication server 120 may interact with a separate server that performs the authentication related to the copyright.

The content provider (e.g., production company, agency, artist, etc.) with the legitimate right to the content (e.g., intellectual property rights such as copyright) may pre-store the identification information of the digital album in the authentication server 120. Here, the identification information of the digital album is the information linked to the physical medium 10 of the digital album (e.g., photo card, etc.) physically provided. The content provider may generate the identification information of the digital album and store the generated identification information of the digital album in the authentication server 120.

The identification information of the content may be pre-stored in the authentication server 120. The identification information of the content may be linked to the physical medium 10. For example, when the user device 10 recognizes the physical medium 10, the user device 10 may acquire the identification information of the content included in the digital album.

The identification information of the digital album may be linked or mapped to the identification information of the content and stored in the authentication server 120. When the authentication server 120 acquires the identification information of the digital album, the authentication server 120 may acquire the identification information of the content linked thereto.

The authentication server 120 may perform the authentication using the identification information acquired from the user device 100 and the identification information pre-stored in the authentication server 120. In this case, the identification information pre-stored in the authentication server 120 may be referred to as the issuance information.

The content providing server 130 may provide services related to the digital album. The content providing server 130 may provide the user device 100 with a web, an application, or a program that may reproduce the digital album or content linked to the digital album at the request of the user device 110.

The content providing server 130 may transmit the content or content information corresponding to the digital album to the user device 110 according to the authentication result of the authentication server 120. The content provided by the content providing server 130 may include various types of content such as novels, movies, music, or webtoons. The content information may include at least one of the text information, the image information, the video information, and the sound source information. The content-related information may include various types of information such as a title, an issuance date, a playback time, an author, a lyricist, a composer, a producer of content, an image representing content, and content information. The content-related data may include data that allows content or content-related information to be displayed or reproduced through the application stored in the user device 110. The user device 110 may acquire the content-related data, and use the content-related data to play the content through the application or display the content-related information. The user device 110 may acquire content information and play content using the content information according to the user's request.

In various exemplary embodiments of the present disclosure, the operation of providing the content may include at least one of the operations of providing the content-related information and the content-related information or the content-related data.

The user device 110 may output at least one of image information, video information, text information, or sound source information according to the acquired content information. For example, when the acquired content information is music video information, the user device 110 may output a music video through a display and speaker.

The relationship information between the digital album and the content may be stored in the content providing server 130 or a database accessible from the content providing server 130. For example, the mapping information between the digital album and the content may be pre-stored in the content providing server 130 or the database. The mapping between the digital album and the content may mean the mapping between the identification information of the digital album and the content-related data or the mapping between the identification information of the digital album and the identification information of the content.

The mapping information between the user device 110 (or user) and the digital album according to the authentication of the authentication server 120 may be pre-stored in the content providing server 130 or the database accessible from the content providing server 130. The mapping information may include the mapping information between the identification information. Alternatively, the mapping information between the user device 110 (or user) and the content may be pre-stored.

Only one user device 100 may be mapped to one digital album. That is, the right to use one digital album may be assigned to only one user device 100. A plurality of digital albums may be mapped to one user device 100. That is, the user device 100 may have the right to use a plurality of purchased digital albums. At least one content may be mapped to one digital album. That is, the digital album may include the plurality of types of content.

In various exemplary embodiments of the present disclosure, it is expressed as the content providing server 130, but the content providing server 130 may be a concept that includes a server providing the types of data that may be transmitted according to the linking with the physical medium 10 and the authentication by the authentication server 120. For example, the data provided by the content providing server 130 may be expanded to various data, such as data including personal information that only a specific user needs to access and data related to a bank account.

Each component in FIG. 1 may be connected to each other through a network 140. As illustrated in FIG. 1, at least one user device 110 may be communicatively connected to the authentication server 120 through the network 140. At least one user device 110 may be communicatively connected to the content providing server 130 through the network 140. The authentication server 120 may be communicatively connected to the content providing server 130 through the network 140.

According to an exemplary embodiment, the network 140 may mean a connection structure that enables information exchange between the respective nodes such as the user device 110 and the servers 120 and 130. Examples of the network may include a local area network (LAN), a wide area network (WAN), the Internet (World Wide Web (WWW)), a wired/wireless data communication network, a telephone network, a wired/wireless television communication network, or the like. Examples of the wireless data communication network may include 3G, 4G, 5G, 3rd generation partnership project (3GPP), 5th generation partnership project (5GPP), long term evolution (LTE), LTE-advanced (LTE-A), world interoperability for microwave access (WiMAX), wireless-fidelity (Wi-Fi), a wide area network (WAN), a personal area network (PAN), radio frequency (RF), Bluetooth, near-field communication (NFC), a satellite broadcast network, an analog broadcast network, a digital multimedia broadcasting (DMB) network, and the like, but are not limited thereto, and various types of wired/wireless communication networks may be included therein.

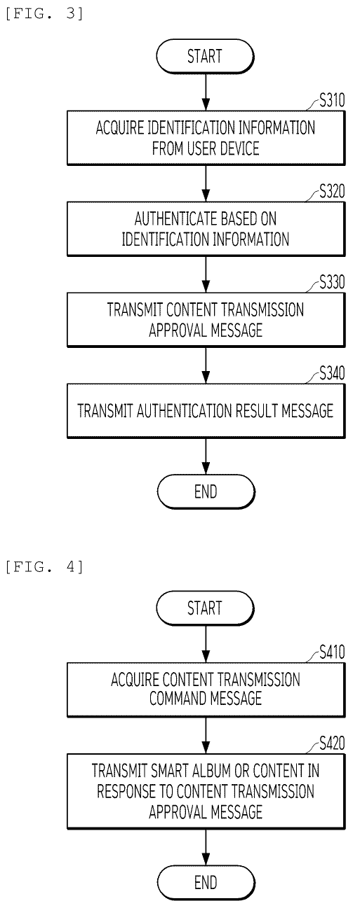

FIG. 2 is a flowchart for describing the method of authenticating a digital album in a user device according to an exemplary embodiment of the present disclosure.

Referring to FIG. 2, the user device (e.g., user device 110 in FIG. 1) may transmit the identification information of the digital album to the authentication server (e.g., authentication server 120 in FIG. 1) and acquire the content corresponding to the digital album from the content providing server (e.g., content providing server 130 in FIG. 1).

In operation S210, the user device may acquire the identification information related to the digital album. The user device may acquire the identification information related to the digital album through the physical medium (e.g., physical medium 10 in FIG. 1). Here, the operation of acquiring the identification information related to the digital album through the physical medium may include an operation of recognizing at least part of the physical medium, an operation of tagging the physical medium, an operation of connecting to the physical medium, or an operation of acquiring, by the user device, the identification information related to the digital album in response to the user directly inputting the code displayed on the physical medium. The user device 110 may acquire the identification information related to the digital album from the physical medium 10.

The identification information related to the digital album may include the identification information of the digital album. Alternatively, the identification information related to the digital album may further include the identification information of the content included in the digital album.

In response to acquiring the identification information related to the digital album, the user device may acquire at least one of location information or information about a distribution channel of the user device. The location information may include, for example, global positioning system (GPS) information. The information on the distribution channel may include, for example, information (e.g., an identifier) on a seller or an intermediary who distributes the digital album.

The user device may include at least one of a camera, a touch screen, an input/output interface (e.g., a universal serial bus (UBS) port), a speaker, or a communication circuit to enable the acquisition of the identification information related to the digital album through the physical medium.

In operation S220, the user device may transmit the identification information of the digital album to the authentication server. The user device may transmit the acquired identification information of the digital album to the authentication server through the communication circuit.

While transmitting the identification information of the digital album, the user device may also transmit the identification information of the user device together. The signal through which the identification information of the digital album is transmitted may include the identification information of the user device.

The identification information of the digital album and the identification information of the user device may be transmitted during the same time period. This may mean that the identification information of the digital album and the identification information of the user device are transmitted on frames divided into the same time period.

When transmitting the identification information of the digital album, the user device may further transmit at least one of the location information of the user device or the information on the distribution channel. The location information may include, for example, the global positioning system (GPS) information. The information on the distribution channel may include, for example, the information (e.g., an identifier) on the seller or intermediary who distributes the digital album.

While transmitting the identification information of the digital album, the user device may also transmit the identification information of the authentication server together. The identification information of the authentication server may be pre-stored on the user device when downloading the application, or may be included in the identification information related to the digital album.

In operation S230, the user device may acquire the digital album or content from the content providing server.

The operation of acquiring the digital album may include the operation of acquiring the information related to the digital album. The information related to the digital album may include at least one of an image indicating a digital album, a producer of a digital album, text related to a digital album, content-related information included in a digital album, content and information related to included in a digital album, authentication of a digital album. The information related to the digital album may include the operation of acquiring the data related to the digital album implemented on the user device through the application. Here, the image indicating the digital album may correspond to or be identical to the image included in the physical medium or goods corresponding to the physical medium.

The content may include various types of content that the user expects to acquire when purchasing the digital album. The content may be composed of at least one of an image, a video, text, or a sound source.

The operation of acquiring the content may include not only content such as the sound source or the video, but also an operation of acquiring content that can be visually confirmed through the application installed on the user device. The operation of acquiring the content may include the operation of acquiring the content-related data.

In operation S240, the user device may output the acquired digital album or content.

The user device may output the acquired digital album or content through the display or the touch screen. The user device may output the digital album through the display or the touch screen. The screen displayed on the user device may include an image that visually represents the digital album.

The user device may display the content-related information through the display or the touch screen. When the content is the sound source, the user device may display at least one of a title, a performer, a lyricist, a composer, a lyrics, or a release date of a sound source, or an image related to the sound source through the display or the touch screen. The user device may output the acquired content. The user device may output the acquired content through an input/output device including at least one of the display, the touch screen, or the speaker based on the content information or the content-related data.

FIG. 3 is a flowchart for describing the method of authenticating a digital album in an authentication server according to an exemplary embodiment of the present disclosure.

Referring to FIG. 3, the authentication server (e.g., authentication server 120 in FIG. 1) may authenticate the digital album of the user based on the identification information of the digital album acquired from the user device (e.g., user device 110 in FIG. 1).

In operation S310, the authentication server may acquire the identification information of the digital album from the user device. The authentication server may acquire the identification information of the digital album from the user device through the network.

When acquiring the identification information, the authentication server may also acquire the identification information of the user device. The identification information of the user device and the identification information of the digital album may be transmitted during the same time period.

When acquiring the identification information, the authentication server may also acquire the location information of the user device. This location information may be transmitted from the authentication server to at least one of the content server or the external server. It may be possible to confirm a consumption path according to the location of the digital album or content by the location information of the user device.

When acquiring the identification information, the authentication may acquire the information on the distribution channel. The information on the distribution channel may be transmitted to at least one of the content server or the external server. It may be possible to confirm whether the digital album has been distributed through a legitimate distribution network by the information on the distribution path.

In operation S320, the authentication server may perform the authentication based on the identification information of the digital album. The authentication server may confirm whether the digital album has been officially issued based on the identification information of the acquired digital album. Alternatively, the authentication server may perform copyright authentication for the digital album or content corresponding to the digital album based on the acquired identification information of the digital album.

The authentication server may determine whether the identification information of the digital album acquired from the user device exists in the memory or the database connected to the authentication server. When the identification information of the digital album acquired from the user device exists in the database, the authentication of the digital album may be determined to succeed. When the identification information of the digital album acquired from the user device does not exist in the database, the authentication of the digital album may be determined to fail.

The authentication server may compare the identification information acquired in operation S310 with the issuance information of the digital album pre-stored in the authentication server. The authentication server may confirm whether the acquired identification information exists among a plurality of types of pre-stored issuance information. When there is the information issuance that matches the identification information acquired from the external device, the authentication server may determine that the digital album indicated by the identification information is genuine. When there is no issuance information that matches the identification information acquired from the external device, it may be determined that the digital album is not genuine. The digital album that has not been officially issued (or is not genuine) may be determined to be replicas or counterfeits.

Artists, intellectual property (IP) holders, or content providers (e.g., production companies, agencies, etc.) may access the authentication server when issuing the digital album. When issuing the digital album, the issuance information corresponding to each digital album may be stored in the authentication server. For example, when 10,000 digital albums are issued, issuance information of 10,000 digital albums may be stored in the authentication server. The issuance information stored in the authentication server may each have different values. In other words, the digital album may be linked to issuance information with different values. When the digital album is an officially released digital album, the issuance information of the digital album and the identification information of the digital album match each other.

According to an exemplary embodiment, the issuance information or the identification information for identifying the digital album has different values for each digital album, while a plurality of digital albums may be linked to the same content. That is, even if different users purchase digital albums with different identification information, the content acquired by the user through the digital albums may be the same.

Depending on the result of operation S320, the authentication server may transmit an authentication result message. The authentication server may generate an authentication result message according to the comparison result or the authentication result. When the authentication succeeds, the authentication server may generate an authentication success message indicating that the issuance information and the identification information match. When the authentication fails, the authentication server may generate an authentication failure message indicating that the issuance information and the identification information do not match. Alternatively, when the issuance information and the identification information do not match, the authentication server may not generate any information.

In operation S330, the authentication server may transmit a content transmission approval message to the content providing server (e.g., content providing server 130 in FIG. 1). The authentication server may transmit the content transmission approval message according to the authentication result. When the authentication of the digital album succeeds, the authentication server may cause the content providing server to transmit the content or digital album.

The content transmission approval message may include at least one of the identification information of the digital album, the identification information of the user device (or user), and the identification information of the content included in the digital album. Preferably, the content transmission approval message may include the identification information of the digital album and the identification information of the user device (or user).

The content transmission approval message may include the information related to the authentication result or information regarding whether the transmission is approved. For example, the content transmission approval message may include a key indicating content transmission approval or authentication success. Alternatively, the content transmission approval message may include an indicator indicating the authentication success or the authentication failure. In some cases, the content transmission approval message may implicitly indicate that the authentication of the digital album succeeds.

The identification information of the content may be acquired from the authentication server based on the identification information of the digital album pre-stored in the authentication server, or the identification information of the content may be transmitted from the user device together with the identification information of the digital album.

Here, the identification: information of the user may include user's identification (ID) using the dedicated application. The user's ID may be expressed in various formats, such as text input by the user, a user's face, or user's biometric data.

In operation S340, the authentication server may transmit the authentication result message to an external device. The authentication result message may indicate the authentication success or the authentication failure, depending on the authentication result.

The authentication server may transmit the authentication result message only when the authentication succeeds. In this case, the authentication result message may implicitly indicate that the authentication succeeds. When the authentication fails, the authentication server may not transmit a separate message.

The external device that receives the authentication result message may be the user device or the content providing server. In addition to this, the external device may include a music chart providing server or a copyright management server in addition to the user device or the content providing server. A separate server other than the user device or the content providing server, for example, a music chart providing server, may acquire the authentication result message(s) and provide a music chart based on the acquired authentication result message(s). For example, the copyright management server may acquire the authentication result message(s) and calculate copyright royalties, etc., based on the acquired authentication result message(s). Although not illustrated in the specification of the present disclosure, the sound source chart providing server may aggregate the sound source charts based on the authentication result message. For example, the music chart providing server may aggregate the music chart using the identification information related to the digital album included in the authentication result message. In this case, the authentication result message may include at least one of the identification information of the digital album or the identification information of the content. The authentication result message is the same as or similar to an authentication response message in the description below.

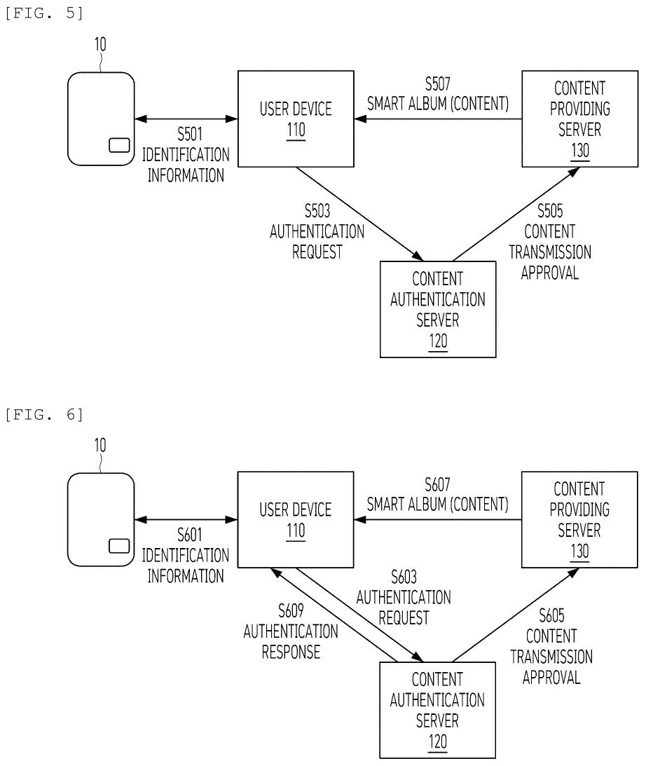

FIG. 4 is a flowchart for describing a method of providing content from a content providing server according to an exemplary embodiment of the present disclosure.

The content providing server (e.g., content providing server 130 in FIG. 1) provides the digital album to the user device (e.g., user device 110 in FIG. 1) according to the authentication of authentication the server (e.g., authentication server 120 in FIG. 1).

In operation S410, the content providing server may acquire the content transmission approval message. The content transmission approval message may include the identification information of the digital album and the identification information of the user device (or user).

Alternatively, the content transmission approval message may include at least one of the identification information of the digital album, the identification information of the user device (or user), and the identification information of the content included in the digital album.

The content transmission approval message may include the information related to the authentication result or information regarding whether the transmission is approved.

In operation S420, the content providing server may transmit the digital album or content in response to the content transmission approval message. The content providing server may transmit the digital album indicated by the identification information included in the content transmission approval message.

The operation of transmitting the digital album may include an operation of transmitting at least one content or the content-related information included in or linked to the digital album.

The operation of transmitting the digital album may include an operation of transmitting a set of data related to the digital album. The user device may acquire the data related to the digital album and use the data to output the digital album through the application. For example, the user device may output the image related to the digital album.

Alternatively, the operation of transmitting the digital album may include the operation of transmitting a set of content-related data corresponding to the digital album. The user device may acquire the content-related data and play content through the application using the data.

The content providing server may transmit the digital album or content to the user device (or user) indicated by the identification information of the user device (or user) included in the content transmission approval message.

When transmitting the content, the content providing server may transmit the content-related information. When the content is the sound source, the content-related information may include at least one of the title, performer, lyricist, composer or copyright holder of the sound source, the lyrics of the sound source, and an issuance date of the sound source. The content-related information may be included in the data related to the digital album.

FIG. 5 is a diagram illustrating an authentication and transmission scenario in a system for authentication of a digital album according to an exemplary embodiment of the present disclosure.

Referring to FIG. 5, the user device 110 acquires the identification information through the physical medium 10, and after the authentication of the digital album is performed in the authentication server 120, the user device 110 may receive the digital album or content from the content providing server 130.

In operation S501, the user device 110 may acquire the identification information related to the digital album through the physical medium 10. The identification information related to the digital album may include the identification information of the digital album purchased by the user through the corresponding physical medium 10.

In operation S503, the user device 110 may transmit an authentication request message to the authentication server 120. The authentication request message may include at least some of the identification information acquired in operation S501. The authentication request message may include the identification information of the digital album.

The authentication server 120 may acquire the identification information of the digital album and acquire the digital album based on the acquired identification information. The authentication server 120 may confirm whether the identification information matches the issuance information of the digital album pre-stored in the authentication server 120. The authentication server 120 may confirm whether any one of the pieces of issuance information matches the plurality of identification information of the digital album.

When any one of the plurality of pieces of issuance information matches the identification information of the digital album, the authentication server 120 may determine that the authentication of the digital album succeeds. When there is no issuance information corresponding to the identification information of the digital album among the plurality of pieces of pre-stored issuance information, the authentication server 120 may determine that authentication of the digital album has failed.

According to an exemplary embodiment, the authentication request message may further include the identification information of the user device (or user) or the identification information of the user. The identification information of the user device (or user) may be transmitted to the authentication server 120 along with the identification information of the digital album. When the authentication of the digital album succeeds, the authentication server 120 may store the identification information of the user device (or user) by linking to the identification information (or issuance information) of the digital album.

When the authentication of the digital album succeeds, the authentication server 120 may perform operation S505.

In operation S505, the authentication server 120 may transmit the content transmission approval message to the content providing server 130.

The content transmission approval message may include the identification information of the digital album and the identification information of the user device (or user). The content providing server 130 may load the content-related data or the data related to the digital album based on the identification information of the digital album. The content-related information may include data or a set of data that allows the content to be implemented or displayed by the processor or application on the user device 110. The data related to the digital album may include data or a set of data that allows the digital album to be implemented or displayed by the processor or application on the user device 110.

The content transmission approval message may include at least one of the identification information of the digital album, the identification information of the content, the identification information of the user device, and the identification information of the user. The content transmission approval message may include the information related to the authentication result or the information related to the transmission approval.

The content may be pre-stored in the content providing server 130 or the database (not illustrated) connected to the content providing server 130. The mapping relationship between the digital album and the content may be pre-stored. The identification information of the digital album and the content corresponding to the digital album may be mapped and stored.

The content transmission approval message may include the identification information of the digital album and the identification information of the user device 110 (or user). The content providing server 130 may acquire the digital album or content using the identification information of the digital album.

The content transmission approval message may include the identification information of the content and the identification information of the user device (or user). The content providing 130 may load content using the identification information of the content. The operation of loading content using the identification information of the content may include the operation of acquiring the content-related data that allows the content to be reproduced on the user device 110.

The content transmission approval message may include the authentication information indicating that authentication of the digital album succeeds. Alternatively, the content transmission approval message itself may implicitly mean that the content has been authenticated. Accordingly, the content transmission approval message transmitted to the content providing server 130 may not include information indicating whether separate authentication is made.

In operation S507, the content providing server 130 may provide a smart album or content to the user device 110.

The operation of providing the smart album may include the operation of providing the content corresponding to the smart album. The operation of providing the smart album may include the operation of transmitting the information related to the smart album.

The operation of providing the content may include various operations of transmitting over air the content to the user device 110. For example, the operation of providing the content may include an operation of downloading the content to the user device 110, an operation of dropping the content, or an operation of streaming the content. The operation of providing the content may include an operation of transmitting the content-related data which is data necessary to reproduce the content on the user device 110.

The operation of providing the content may include the operation of providing the content-related information. For example, the content-related information may include at least one of the title of the content, performer, producer, lyricist, composer, lyrics, or release date of the content (or digital album).

According to an exemplary embodiment, there may be a plurality of types of content provided to the user device 110. The content provided to the user device 110 may include at least one of text, sound, image, or video. The content may include various types of content such as sound sources, music videos, artist videos, or artist letters.

The content providing server 130 may transmit the information related to the authentication result of the information regarding whether the transmission is approved. For example, the content providing server 130 may transmit a key indicating the content transmission approval or the authentication success to the user device 110. The user device 110 may display an authentication-related message on the display in response to the information related to the authentication result. The content providing server 130 may acquire the key from the authentication server 120 or generate the key in response to the content transmission approval message.

The key indicating the transmission approval of the content or the authentication success may mean permission to access the content or the smart album. The user device 110 may later transmit the key to the content providing server 130 when requesting the transmission or streaming of content to the content providing server 130. The content providing server 130 may provide or stream content to the user device 110 based on the key value.

The content providing server 130 may transmit an indicator indicating the authentication success or authentication failure. According to the indicator, the user device 110 may display the authentication-related message through the display. The content providing server 130 may acquire the indicator from the authentication server 120 or generate the key in response to the content transmission approval message.

Alternatively, the operation of providing the content may implicitly mean that the authentication has been successfully performed.

The user device 110 may display the acquired content through the display or the touch screen. For example, a thumbnail designated for the content or a screen representing the content may be displayed through the display or touch screen of the user device 110.

The user device 110 may display the authentication message on the user device 110 in response to acquiring the content or the content-related information. The user device 110 may display an authentication message overlaid on the execution screen included installed application. The in the authentication message may indicate that the digital album or content has been officially released or has been duly issued by the copyright holder. The authentication message may be a push message or a pop-up message.

In this way, by integrating and managing the authentication of the digital album through the authentication server 120, the artist or content provider may confirm the distribution status of the digital album. The artist or content provider may transparently manage the distribution of the digital content through the digital album. Accordingly, the artists or content providers may receive fair compensation for digital content. Through this, a healthy content consumption culture may be established under a digital album supply system.

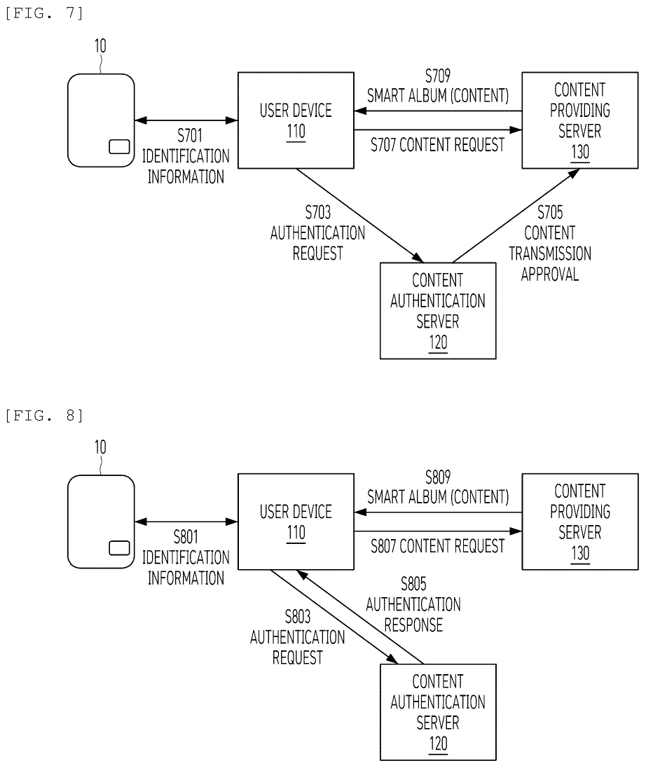

FIG. 6 is a diagram illustrating an authentication and transmission scenario in a system for authentication of a digital album according to an exemplary embodiment of the present disclosure.

Referring to FIG. 6, after the authentication of the digital album is performed in the authentication server 120, the user device 110 may directly acquire the authentication response message from the authentication server 120.

The user device 110 may acquire the identification information of the digital album through the physical medium 10 in operation S601, transmit an authentication request message to the authentication server 120 in operation S603, and transmit the content transmission approval message to the content providing server 130 in operation S605. The content providing server 130 may transmit content to the user device 110 in operation S607. Operations S601 to S607 may each refer to operations S501 to S507 of FIG. 5.

After acquiring the identification information in operation S603, the authentication server 120 may perform the authentication on the digital album based on the identification information. After performing the authenticating on the digital album, the authentication server 120 may transmit the authentication response message to the user device 110 in operation S609.

According to an exemplary embodiment, the authentication response message may include the information indicating the authentication success or the information indicating the authentication failure. Alternatively, the authentication response message may implicitly indicate that the authentication succeeds. When the authentication fails, the authentication response message may not be transmitted. The content transmission approval message may include the indicator indicating the authentication success or the authentication failure.

According to an exemplary embodiment, the authentication response message may include the identification information of the digital album that has been a subject of authentication. The authentication response may message include the identification information of at least one of the user device 110 or the user.

In response to the authentication response message, the user device 110 may output the authentication message related to the digital album through the display or the touch screen. The authentication message related to the digital album may indicate whether the digital album is genuine. The user device 110 may also output the authentication message only when the authentication succeeds.

The authentication response message may include a key indicating the transmission approval of the content or the authentication success. The key indicating the transmission approval of the content or the authentication success may refer to permission to access the content or the smart album. The user device 110 may later transmit the key to the content providing server 130 when requesting the transmission or streaming of content to the content providing server 130. The content providing server 130 may provide or stream content to the user device 110 based on the key value.

When the authentication response message implicitly indicates that the authentication succeeds, if the user device 110 acquires the authentication response message, the authentication message indicating the authentication success may be displayed on the application execution screen.

When the authentication response message is not transmitted within a certain period of time, the user device 110 may determine that the authentication has failed. The user device 110 may display the authentication message indicating that the authentication has failed on the application execution screen.

The sequence of operations illustrated in FIG. 6 may be changed according to various exemplary embodiments. For example, operation S609 may be performed simultaneously with operation S605, before operation S605, or immediately after operation S605.

FIG. 7 is a diagram illustrating an authentication and transmission scenario in a system for authentication of a digital album according to an exemplary embodiment of the present disclosure.

Referring to FIG. 7, in response to acquiring identification information, the user device 110 may transmit the authentication request message and the content request message to the content authentication server 120 and the content providing server 130, respectively. The content transmission performed in response to the content request message may be performed after the authentication of the authentication server 120 is completed.

In operation S701, the user device 110 may acquire the identification information related to the digital album through the physical medium 10. Operation S701 may refer to the description of operation S501.

In operation S703, the user device 110 may transmit the authentication request message to the authentication server 120. Operation S703 may refer to operation S503.

In operation S705, the authentication server 120 may transmit the content transmission approval message to the content providing server 130. Operation S705 may refer to operation S505.

In operation S707, the user device 110 may transmit the content request message to the content providing server 130. The user device 110 may transmit the content request message to the content providing server 130 in response to acquiring the identification information related to the digital album.

The content request message and the authentication request message may be transmitted within the same time interval or may be transmitted in different time intervals, but these request messages may be transmitted within a close time interval.

The content message request may include the identification information of the user device 110 (or user) and the identification information related to the digital album. The identification information related to the digital album may include at least one of the identification information of the digital album or the identification information of the content included in the digital album.

In operation S709, the content providing server 130 may transmit the digital album or content to the user device 110 in response to the content request message and the content transmission approval message. The operation of transmitting the digital album or content may refer to the operation S507 of FIG. 5.

Referring back to operation S705, the content transmission approval message may include the identification information of the digital album.

The content providing server 130 may be set to manage or control the content on a digital album basis. In this case, the content transmission approval message may include the identification information of the digital album. Similarly, the content request message may include the identification information of the digital album.

The content providing server 130 may transmit the digital album to the user device 110 when the identification information of the digital album included in the content transmission approval message and the identification information of the digital album included in the content request message match each other. This may be on the premise that the identification information of the user device (or user) included in the content transmission approval message and the identification information of the user device (or user) included in the content request message match.

The content transmission approval message of operation S705 may include the identification information of the user device 110 (or user). The content providing server 130 may link the user device 110 (or user) and the digital album according to the content transmission approval message to store the digital album. As described above, the linking and storing may mean storing the mapping information between the identification information. The mapping information between the identification information may be stored in the database in the table form.

The content request message of operation S707 may include the identification information of the user device 110 (or user). The content providing server 130 may confirm whether the identification information of the user device 110 (or user) included in the content request message matches the identification information of the user device 110 (or user) included in the content transmission approval message in response to the content request message. The content transmission request message may include at least one of the identification information of the digital album or the identification information of the content.

When the identification information included in the content request message and the identification information included in the content transmission approval message match each other, the content providing server 130 may transmit the digital album to the user device 110. The content providing server 130 may read at least one content using the identification information of the digital album and transmit the content to the user device 110.

The content providing server 130 may confirm whether the identification information of the user device 110 (or the user) and the identification information of the digital album all match.

The content providing server 130 may link the identification information of the digital album included in the content approval message and the identification information of the user device 110 (or the user) to store the identification information in the database.

The content providing server 130 may also confirm whether the identification information of the digital album included in the content request message and the identification information of the user device 110 (or user) matches the identification information of the pre-stored digital album and the identification information of the user device 110 (or user). When the identification information of the digital albums matches each other and the identification information of the user device 110 (or the user) matches each other, the content providing server 130 may transmit the digital album or the content included in the digital album to the user device 110.

By using the plurality of types of identification information for authentication, the authority of the content provider (e.g., artist, etc.) for content may be further strengthened.

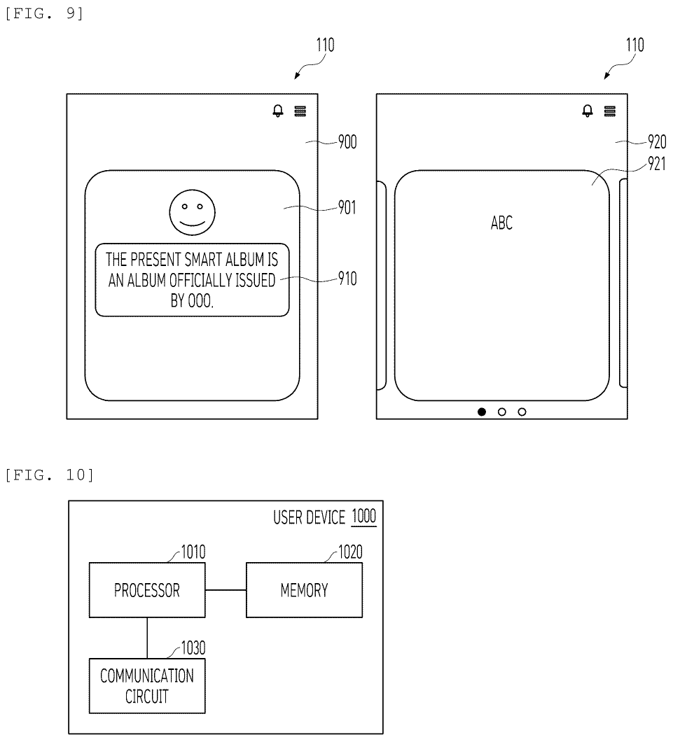

FIG. 8 is a diagram illustrating an authentication and transmission scenario in a system for authentication of a digital album according to an exemplary embodiment of the present disclosure.

Referring to FIG. 8, the authentication server 120 may only perform authentication procedures and may not be directly involved in content transmission.

In operation S801, the user device may acquire the identification information of the digital album through the physical medium 10 and transmit the authentication request message to the authentication server 120 in operation S803. Operations S801 to S803 may refer to operations S501 to S503 of FIG. 5.

In operation S805, the authentication server 120 may transmit the authentication response message in response to the authentication request message. The authentication response message may include an authentication success message indicating the authentication success or an authentication failure message indicating the authentication failure. Alternatively, the authentication response message may be transmitted only when the authentication succeeds. In this case, the authentication response message may implicitly indicate that the authentication succeeds. A description of operation S805 may refer to the description of operation S605 of FIG. 6.

In operation S807, the user device 1110 may transmit the content request message to the content providing server 130. The content request message may include the identification information of the user device 110 and the identification information of the digital album.

The content request message may include a key indicating the content transmission approval or the authentication success. The key indicating the transmission approval of the content or the authentication success may refer to permission to access the content or the smart album. Alternatively, the content request content may include an indicator indicating the transmission approval of the content.

The user device 110 may transmit the content request message to the content providing server 130 only when the authentication succeeds. The user device 110 may implicitly or directly transmit the content request message when the authentication response message indicates the authentication success. Operation S807 may refer to the description of operation S707 of FIG. 7.

In operation S809, the content providing server 130 may transmit the digital album or content to the user device 110 in response to the content request message. The content providing server 130 may read the content based on the identification information of the digital album and transmit the read content to the user device 110. In this case, the content providing server 130 may transmit the digital album or content according to the key included in the content request message. A description of operation S809 may refer to the descriptions of operation S507 of FIG. 5, operation S607 of FIG. 6, and operation S709 of FIG. 7.

FIG. 9 is a diagram illustrating an authentication screen of a user device according to an exemplary embodiment of the present disclosure.

Referring to FIG. 9, the user device 110 may output a message 910 related to the authentication of the digital album through the touch screen or the display.

The digital album may be implemented through the application installed on the user device 110. Implementing the digital album may mean that at least one content included in or constituting the digital album is played by an application or displayed on an execution screen through the application.

Referring to FIG. 9, when the user device 110 authenticates and downloads the digital album, the digital album may be displayed on an execution screen 900 of the application. In other words, the execution screen 900 including an image 901 representing the digital album may be output through the display. When downloading the digital album, the user device 110 may display a message 910 related to the authentication of the digital album through the display. The authentication-related message 910 may be disposed on the execution screen 900 in the form of a pop-up message or a push message. The execution screen 900 and the authentication-related message 910 are displayed together on the display, but may form different layers.

When the digital album is selected by clicking, touching, applying pressure, or inputting voice through the display or the touch screen on the execution screen 900, another execution screen 920 displaying content 921 included in the digital album may be output through the display. When the user swipes the display or the touch screen while another execution screen 920 including the content 921 corresponding to the digital album is displayed, the content 921 included in the digital album may move in the swiped direction. As the content 921 moves, the user may confirm various types of content included in the digital album through the display.

The authentication-related message 910 illustrated in FIG. 9 is an example, and the authentication-related message 910 is not limited thereto and may include messages with various contents.

The operations illustrated in FIGS. 3 to 9 may be operated in combination with each other as needed. In addition, the content authentication method provided in the exemplary embodiments described in the present disclosure may be applied to various fields that require the distribution of legitimate rights. For example, when the user device interacts with a physical medium corresponding to a ticket, the identification information of the thicket may be transmitted to the authentication server to authenticate the ticket. Depending on the authentication of the authentication server, a digital ticket may be transmitted from the content server to the user device. The digital ticket may include at least one of an image, a video, or text. In addition, the digital ticket is in the form of the NFT and may be transmitted in the form that complies with standard specifications related to the NFT.

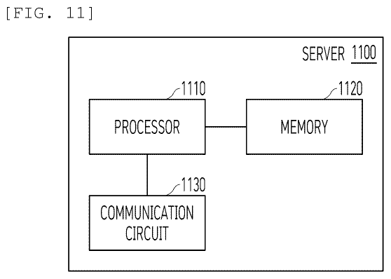

FIG. 10 is a block diagram illustrating a configuration of a user device according to an exemplary embodiment of the present disclosure.

A user device 1000 (e.g., user device 110 in FIG. 1) according to various exemplary embodiments of the present disclosure may include a processor 1010, a memory 1020, and a communication circuit 1030.

The processor 1010 may perform the methods or operations described in FIGS. 1 to 9 in relation to the user device 1000. The processor 1010 may be electrically connected to the memory 1020 and the communication circuit 1030. The processor 1010 may perform a method or operation according to instructions stored in the memory 1020. Codes or instructions related to programs or applications executed by the processor 1010 may be stored in the memory 1020.

The memory 1020 may store information for performing the methods or operations described in FIGS. 1 to 9. For example, the memory 1020 may store instructions that, when executed by the processor, perform the methods or operations described in various exemplary embodiments of the present disclosure. The memory 1020 may include a volatile memory or a nonvolatile memory.

The user device 1000 may be connected to another user device or a server (e.g., the server 1100 in FIG. 11) through the communication circuit 1030. The user device 1000 may transmit or receive signals, data or messages to and from another user device or server through the communication circuit 1030. The user device 1000 may access a network (e.g., network 140 in FIG. 1) through the communication circuit 1030.

In the various exemplary embodiments described above, the operation of the user device (e.g., user device 110 in FIG. 1) may be understood as the operation of the processor.

The configuration of the user device 1000 illustrated in FIG. 10 is exemplary, and the user device 1010 may further include other general-purpose components. For example, the user device 1000 may further include various components such as a camera, a speaker, a touch screen, and an input/output interface.

FIG. 11 is a block diagram illustrating a configuration of a server according to an exemplary embodiment of the present disclosure.

The server 1100 (e.g., the authentication server 120 or content providing server 130 in FIG. 1) according to various exemplary embodiments of the present disclosure may include a processor 1110, a memory 1120, and a communication circuit 1130.

The processor 1110 may perform the methods or operations described in FIGS. 1 to 9 in relation to the server 1100. The processor 1110 may be electrically connected to the memory 1120 and the communication circuit 1130. The processor 1110 may perform a method or operation according to instructions stored in the memory 1120. Codes or instructions related to programs or applications executed by the processor 1110 may be stored in the memory 1120.

The memory 1120 may store information for performing the methods or operations described in FIGS. 1 to 9. For example, the memory 1120 may store instructions that, when executed by the processor, perform the methods or operations described in various exemplary embodiments of the present disclosure. The memory 1120 may include a volatile memory or a nonvolatile memory.

The server 1100 may be connected to a user device (e.g., the user device 110 in FIG. 1) or another server through the communication circuit 1130. The server 1100 may transmit or receive signals, data, or messages to and from other user devices or servers through the communication circuit 1130, and may access the network (e.g., network 140 in FIG. 1) through the communication circuit 1130.

In various exemplary embodiments described above, the operation of the authentication server or content providing server may be understood as the operation of the processor.

The configuration of the server 1100 illustrated in FIG. 11 is exemplary, and the server 1100 may further include other general-purpose components. Although not illustrated in FIG. 11, the server 1100 may include a database capable of storing a large amount of data or may be configured to provide access to data.

Although it has been described that all components configuring the exemplary embodiment of the present disclosure are combined with each other as one component or are combined and operated with each other as one component, the present disclosure is not necessarily limited to the above-described exemplary embodiment. That is, all the components may also be selectively combined and operated with each other as one or more components without departing from the scope of the present disclosure.

Methods according to the exemplary embodiments described in the claims or specifications of the present disclosure may be implemented in the form of hardware, software, or a combination of the hardware and software.

When the exemplary embodiments of the present disclosure are implemented in software, a computer-readable storage medium storing one or more programs (software modules) or instructions may be provided. One or more programs or instructions stored in the computer-readable storage medium are configured to be executable by one or more processors in an electronic device. One or more programs include instructions for causing an electronic device to execute methods according to exemplary embodiments described in a claim or specification of the present disclosure.

These programs (software module and software) may be stored in random access memory (RAM), non-volatile memory including flash memory, read only memory (ROM), electrically erasable programmable read only memory (EEPROM), a magnetic disc storage device, compact disc-ROM (CD-ROM), digital versatile discs (DVD) or other optical storage devices, a magnetic cassette, or other magnetic storage devices. Alternatively, the program may be stored in a memory composed of a combination of some or all thereof. In addition, each configuration memory may be included multiple in user devices, electronic devices, external devices, or servers.

Additionally, components, units, modules, components, etc., described as “˜ unit” in the present disclosure may be implemented together or individually as separate but interoperable logic devices. The descriptions of different features for modules, units, etc., are intended to highlight different functional exemplary embodiments and do not necessarily imply that they should be realized by individual hardware or software components. Rather, functionality associated with one or more modules or units may be performed by separate hardware or software components or may be integrated within common or separate hardware or software components.

In addition, the program may be stored in an attachable storage device that may access through a communication network such as the Internet, the Intranet, a local area network (LAN), wide LAN (WLAN), or a storage area network (SAN), or a combination thereof. Such a storage device may be connected to a device implementing an exemplary embodiment of the present disclosure through an external port. In addition, a separate storage device on the communication network may be connected to the device implementing the exemplary embodiment of the present disclosure.

Each block of the flowcharts of FIGS. 1 to 11 and combinations of the flowcharts may be understood as being performed by computer program instructions. These computer program instructions may be mounted on processors of a general-purpose computer, a special-purpose computer, or other programmable data processing apparatuses. Accordingly, those instructions executed through the processors of the computer or other programmable data processing apparatuses generate a means of performing the functions described in the block(s) of the flowchart. Since these computer program instructions can also be stored in a memory or computer readable memory available to a computer device that may be directed to a computer or other programmable data processing apparatuses in order to implement the functions in a specific scheme, the instructions stored in these memories can also produce manufacturing articles including instruction means performing the functions described in the block(s) of the flowchart. Since the computer program instructions can also be mounted on the computer or the other programmable data processing apparatuses, the instructions performing a series of operation steps on the computer or the other programmable data processing apparatuses to create processes executed by the computer, thereby executing the computer or the other programmable data processing apparatuses can also provide steps (or operations) for performing the functions described in a block(s) of the flowchart.

In addition, each block may indicate some of modules, segments, or codes including one or more executable instructions for executing a specific logical function (specific logical functions). Further, it is to be noted that functions mentioned in the blocks occur regardless of a sequence in some alternative exemplary embodiments. For example, two blocks that are continuously illustrated can be substantially simultaneously performed in fact or sometimes be performed in a reverse sequence depending on corresponding functions.

In this document, components included in the disclosure are expressed in singular or plural numbers depending on the specific exemplary embodiments presented. The term “at least one” is defined as terms including singular or plural numbers. However, this expression is selected to suit the presented situation for convenience of description, and each component may exist in singular or plural numbers without the term “at least one”. Even components expressed in plural numbers may be composed of a singular number, or even components expressed in a singular number may be composed of plural numbers.

Hereinabove, the optimal exemplary embodiments of the present disclosure have been disclosed in the accompanying drawings and the specification. In the present specification, although specific terms have been used, they are used only in order to describe the present disclosure and are not used in order to limit the meaning or the scope of the present disclosure, which is disclosed in the appended claims. Therefore, it will be understood by those skilled in the art that various modifications and equivalent other exemplary embodiments are possible therefrom. In addition, each exemplary embodiment may be operated in combination with each other as needed. Accordingly, an actual technical scope of the present disclosure is to be determined by the spirit of the appended claims.

What is claimed is:

1. A method of authenticating a digital album performed on a user device, comprising:
acquiring identification information related to the digital album;
transmitting the acquired identification information to a first server for the authentication of the digital album; and
receiving at least one content corresponding to the identification information from a second server different from the first server.

2. The method of claim 1, further comprising:
outputting a screen including an image of the digital album through a display in response to the operation of receiving the at least one content,
wherein the at least one content includes the image of the digital album.

3. The method of claim 1, further comprising outputting a screen including a message related to the authentication of the digital album through a display.

4. The method of claim 1, wherein the identification information related to the digital album is linked to a physical medium physically separated from the user device.

5. The method of claim 1, wherein the at least one content includes at least one of a video, a sound source, an image, or text, and
the operation of receiving the at least one content includes receiving data related to at least one of the video, sound source, image, or text.

6. A method of authenticating a digital album performed on a first server, comprising:
acquiring identification information related to the digital album from a user device;
comparing issuance information pre-stored in the first server and the acquired identification information; and
transmitting a message including the identification information related to the digital album and identification information of the user device to a second server according to the comparison result.

7. The method of claim 6, further comprising:
transmitting a message related to the comparison result to the user device.

8. The method of claim 6, wherein at least one content corresponding to the identification information related to the digital album is transmitted from the second server to the user device according to the message.

9. The method of claim 8, wherein the at least one content includes at least one of a video, a sound source, an image, or text.

10. A method of providing a digital album from a first server, comprising:
receiving identification information related to the digital album and identification information of a user device from an external second server; and
transmitting at least one content corresponding to the identification information related to the digital album to the user device.

11. The method of claim 10, wherein the identification information related to the digital album is linked to a physical medium physically separated from the user device.

12. The method of claim 10, wherein the at least one content includes at least one of a video, a sound source, an image, or text, and
the operation of transmitting the at least one content includes transmitting data related to at least one of the video, sound source, image, or text.

13. A user device, comprising:
a memory;
a communication circuit; and
a processor connected to the memory and the communication circuit,
wherein, the memory stores instructions executed to enable the processor to:
acquire identification information related to a digital album,
transmit the acquired identification information to a first server for authentication of the digital album, and
receive at least one content corresponding to the identification information from a second server different from the first server.

14. A server, comprising:
a memory;
a communication circuit; and
a processor connected to the memory and the communication circuit,
wherein, the memory stores instructions executed to enable the processor to:
acquire identification information related to a digital album from a user device,
compare issuance information pre-stored in the server and the acquired identification information, and
transmit a message including the identification information related to the digital album and identification information of the user device to an external server.

15. A server, comprising:
a memory;
a communication circuit; and
a processor connected to the memory and the communication circuit,
wherein, the memory stores instructions executed to enable the processor to:
receive identification information related to a digital album and identification information of a user device from an external server, and
transmit at least one content corresponding to the identification information related to the digital album to the user device.
